(19) United States
(12) Patent Application Publication
(10) Pub. No.: US 2015/0360973 A1
(43) Pub. Date: Dec. 17, 2015

(54) METHODS AND SYSTEMS FOR WATER RECOVERY

(71) Applicants: Aharon EYAL, Jerusalem (IL); Carmi RAZ, Gizo (IL); Paul MCWILLIAMS, Racine,, WI (US)

(72) Inventors: Aharon EYAL, Jerusalem (IL); Carmi RAZ, Gizo (IL); Paul MCWILLIAMS, Racine, WI (US)

(21) Appl. No.: 14/763,926

(22) PCT Filed: Nov. 20, 2013
(86) PCT No.: PCT/IB2013/060283

§ 371 Date: Jul. 28, 2015

Related U.S. Application Data
(60) Provisional application No. 61/906,112, filed on Nov. 19, 2013.
(60) Provisional application No. 61/902,174, filed on Nov. 9, 2013.
(60) Provisional application No. 61/819,195, filed on May 3, 2013.
(60) Provisional application No. 61/757,389, filed on Jan. 28, 2013.

(51) Int. Cl. C02F 1/26; C02F 1/44; B01D 11/04; C02F 1/04

(52) U.S. Cl. CPC C02F 1/26; C02F 1/048; C02F 1/441; B01D 11/0415; B01D 11/0488; C02F 2101/32

(57) ABSTRACT

Disclosed are methods and systems for water recovery

### RELATED APPLICATIONS

The present application gains priority from U.S. Provisional patent applications U.S. 61/757,369 filed on 28 Jan. 2013; U.S. 61/819,195 filed on 3 May 2013; U.S. 61/902,174 filed on 9 Nov. 2013; and U.S. 61/906,112 filed on 19 Nov. 2013 all which are incorporated by reference as if fully set-forth herein.

### FIELD OF THE INVENTION

The invention is in the field of water treatment.

### BACKGROUND OF THE INVENTION

Water, like many other natural resources, is present on earth in a finite amount. More than 95% of the water on Earth is present as brackish water or sea water containing a salt concentration which renders it unsuitable for many purposes.

It is estimated that more than two thirds of the remaining non-salty water is present as ice, primarily in polar caps and glaciers.

This means less than 1% of the water on earth is available as fresh water.

This small fraction of fresh water must sustain not only life, but industry. Although the demand for potable water increases with the world's population, direct consumption of water by man (i.e. drinking water) and indirect consumption by man (e.g. bathing, laundry, in sanitary installations) makes up a relatively small percentage of total water consumption in the world.

The bulk of total water consumption in the world is in industrial processes, including use as a cooling medium.

For example, The National Energy Board of Canada (2006) estimated that about 2 to 4.5 barrels of fresh water are used to produce a barrel of synthetic crude oil. Total water consumption for production of synthetic crude was projected to reach 529 million cubic meters/year. Wastewater from synthetic crude oil production is alkaline, and brackish.

Induced hydraulic fracturing (A.K.A. fracking) for production of natural gas and other petrochemicals from shale also consumes significant amounts of water. It is estimated that 20% to more than 40% of fracking water is recovered either as flow-back water or as produced water.

In the state of Pennsylvania alone the amount of high-TDS (total dissolved solids) wastewater produced by fracking and needing disposal was projected to reach to 7300 million gallons per year in 2011 by the natural gas industry. Levels of salt in fracking water can be more than six times higher than in sea water.

### SUMMARY OF THE INVENTION

A broad aspect of the invention relates to separation of usable water from a stream of water containing hydrophilic, or water soluble, contaminants. In some exemplary embodiments of the invention, the stream is an effluent from an industrial process and the usable water is sufficiently purified to be re-used in the same industrial process.

As used in this specification and the accompanying claims the term “bi-directional solvent” indicates an organic solvent, which is characterized in that on equilibrating at 20° C. with 5% (w/w) NaCl aqueous solution, solvent concentration in the aqueous phase is at least 1% and less than 50% (W/W) and water concentration in the solvent phase is at least 5% and less than 50% (W/W) or a mixture of two or more such solvents.

Examples of bi-directional solvents include, but are not limited to alcohols of 3 to 6 carbons and/or ketones of 3 to 6 carbons and/or esters of 3 to 6 carbons and/or organic acids of 3 to 6 carbons and amines. In some embodiments, the bi-directional solvent includes butanol. In some embodiments, butanol is the primary active component in a mixture of bi-directional solvents. In some embodiments, butanol serves as the sole active bi-directional solvent. Alternatively or additionally, in some embodiments one or more bi-directional solvents comprises one or more members of the group consisting of normal butanol, secondary butanol, isobutanol, tertiary butanol, normal pentanol, secondary pentanol, isopentanol and tertiary pentanol. Alternatively or additionally, in some embodiments one or more bi-directional solvents are provided as an extractant. Optionally, the extractant includes components which are not bi-directional solvents. According to an embodiment, the extractant comprises water.

Another aspect of some embodiments of the invention relates to recovery of usable water from the contaminated wastewater stream without solidification (e.g. precipitation and/or crystallization) of contaminants.

According to various exemplary embodiments of the invention a water stream to be treated includes one or more hydrophilic solutes and optionally one or more hydrophobic solutes.

As used in this specification and the accompanying claims the term “hydrophilic solute” indicates a solute with a log P≦−0.5. According to various exemplary embodiments of the invention the log P of the hydrophilic solute is −0.55; −0.6 −0.65; −0.7; −0.75; −0.8 or intermediate or lesser values. According to various exemplary embodiments of the invention, the term “hydrophilic solute” includes ionic compounds.

As used in this specification and the accompanying claims the term “hydrophobic solute” indicates a solute with a log P≧0.0. According to various exemplary embodiments of the invention the log P of the hydrophobic solute is 0.1; 0.15; 0.2; 0.25; 0.3; 0.35 or intermediate or greater values. According to various exemplary embodiments of the invention, the term “hydrophobic solute” indicates organic compounds with C:O atom ratio greater than 3.

One aspect of some embodiments of the invention relates to treatment of product process water containing both hydrophilic solutes and hydrophobic solutes. In some exemplary embodiments of the invention, the hydrophobic solutes are crude-oil-associated.

As used in this specification and the accompanying claims the terms “wastewater stream” and “product process water” are interchangeable or said “wastewater stream” comprises “product process water”. Hence, according to an embodiment, said wastewater stream comprises product process water mixture with another stream. According to an embodiment, said other stream comprises make-up water. According to a related embodiment, said make-up water comprises brackish water or sea water.

As used in this specification and the accompanying claims the term “crude-oil-associated” indicates materials present in crude oil (i.e. unrefined oil), materials produced during refining of crude oil or chemical conversion of crude oil, materials present in produced gas, materials produced during refining of produced gas or chemical conversion of produced gas. According to various exemplary embodiments of the invention, the term crude oil includes fossil oil and/or vegetable oil (e.g. Palm Oil Mill Effluent—POME). In some embodiments, crude-oil-associated hydrophobic solutes are present in the wastewater stream at concentrations of 10 PPM, 25 PPM, 50 PPM 100 PPM, 200 PPM, 300 PPM, 400 PPM or 500 PPM or intermediate or higher concentrations.

As used in this specification and the accompanying claims, the terms “distillation” and “evaporation” are used interchangeably.

As used in this specification and the accompanying claims, the terms “water-depleted” and “water-enriched” mean containing less water and more water, respectively, compared with the content prior to contacting, in terms of amount or flux or concentration.

In some exemplary embodiments of the invention, there is provided a method including:

(a) first contacting at least a portion of a wastewater stream including one or more hydrophilic solutes with an extractant including a bi-directional solvent to form a water-depleted first aqueous solution and a water-enriched first organic phase;

(b) second contacting the first organic phase with a concentrated aqueous solution, to form a second organic phase and a second aqueous solution;

(c) separating water from the second aqueous solution to form a concentrated aqueous solution and separated water;

(d) recycling the concentrated aqueous solution to the second contacting; and

(e) recycling bi-directional solvent from the second organic phase to the first contacting;

wherein water partial vapor pressure at 50° C. of the wastewater stream, the water-depleted first aqueous solution, the concentrated aqueous solution and the second aqueous solution are P1, P2, P3 and P4, respectively; and wherein the bi-directional solvent is selected so that P1>P2; P1>P3 and P4>P3.

According to various exemplary embodiments of the invention the first contacting is done at temperature higher than 1° C., 10° C., 20° C., 30° C. or 40° C. and lower than 99° C., 90° C., 80° C., 70° C. or 60° C.

According to various exemplary embodiments of the invention the second contacting is done at temperature higher than 1° C., 10° C., 20° C., 30° C. or 40° C. and lower than 99° C., 90° C., 80° C., 70° C. or 60° C.

Alternatively or additionally, in some embodiments, the wastewater stream includes one or more crude-oil-associated hydrophobic solutes. Alternatively or additionally, in some embodiments, the method includes separating at least a portion of the one or more crude-oil-associated hydrophobic solutes from at least a portion of the second organic phase.

Alternatively or additionally, in some embodiments separating water includes heating the second aqueous solution.

Alternatively or additionally, in some embodiments the heating separates a gaseous and/or solid compound, and the method comprises contacting the separated gaseous and/or solid compound with a third aqueous solution to form the concentrated aqueous solution.

Alternatively or additionally, in some embodiments the gaseous or solid compound includes at least one member of the group consisting of NH₃, CO, CO₂, CaCl2, Ca(NO2)3, KBr, KCl, KHCO3, K2SO4, MgCl2, MgSO4, NaCl, NaHCO3, Na2SO4, NH4C1, (NH₄)₂CO₃, (NH₄)HCO₃, H₂NCOONH₄ and (NH4)2SO4.

Alternatively or additionally, in some embodiments the concentrated aqueous solution includes an ammonium compound.

Alternatively or additionally, in some embodiments the second aqueous solution comprises at least a portion of the bi-directional solvent and the heating separate a third organic phase.

Alternatively or additionally, in some embodiments separating water includes contacting the second aqueous solution with a membrane to form separated water and a retentate.

Alternatively or additionally, in some embodiments the method is characterized in that the membrane is a reverse osmosis membrane.

Alternatively or additionally, in some embodiments the second aqueous solution comprises at least a portion of the bi-directional solvent and the retentate comprises a fourth organic phase.

Alternatively or additionally, in some embodiments the method includes recycling at least a portion of the third organic phase or at least a portion of the fourth organic phase to the first contacting.

Alternatively or additionally, in some embodiments the separating water includes heating the second aqueous solution and contacting the second aqueous solution with a membrane.

Alternatively or additionally, in some embodiments the method is characterized in that the separated water comprises at least 60% of the water in said at least a portion of the wastewater stream.

Alternatively or additionally, in some embodiments P2>P3. Alternatively or additionally, in some embodiments P1>P4.

Alternatively or additionally, in some embodiments the bi-directional solvent has a greater affinity to monovalent ions compared to divalent ions; the wastewater stream includes at least one multivalent ion and at least one monovalent ion at a multivalent to monovalent ion ratio R1, the first aqueous solution includes at least one multivalent ion and at least one monovalent ion at a multivalent to monovalent ion ratio R2, and R2 is similar to R1.

Alternatively or additionally, in some embodiments the wastewater stream includes at least one multivalent ion and at least one monovalent ion at a multivalent to monovalent ion ratio R1, the concentrated aqueous solution includes at least one multivalent ion and at least one monovalent ion at a multivalent to monovalent ion ratio R3, and R3>R1.

Alternatively or additionally, in some embodiments both the wastewater stream and the concentrates aqueous solution include at least one multivalent ion and the composition of multivalent ions in said wastewater stream is different from the composition of multivalent ions in the concentrated aqueous solution.

Alternatively or additionally, in some embodiments the method includes contacting at least a fraction of at least one of the first organic phase and the second organic phase with a hydrophobic solvent having a C:O ratio at least 2 times greater than the C:O ratio in the bi-directional solvent.

Alternatively or additionally, in some embodiments the one or more crude-oil-associated hydrophobic solutes include at least one member of the group consisting of naphthenic acid, other organic acids comprising at least 5 carbon atoms, 1,4-dioxane, acetone, bromoform, dibenzo(a,h)anthracene, pyridine, phenols and oil.

Alternatively or additionally, in some embodiments the second organic phase includes at least 85% of the one or more crude-oil-associated hydrophobic solutes in said wastewater stream.

Alternatively or additionally, in some embodiments the water-depleted first aqueous solution comprises at least 80% of the one or more hydrophilic solutes in the wastewater stream.

Alternatively or additionally, in some embodiments the method includes recycling at least 50% of water from the wastewater stream to an industrial process producing the wastewater stream.

Alternatively or additionally, in some embodiments the wastewater stream includes blowdown of steam generator.

Alternatively or additionally, in some embodiments the method includes softening said wastewater stream to form a softened feed stream and feeding the softened feed stream to a steam generator to form steam and a blowdown stream.

Alternatively or additionally, in some embodiments the wastewater stream is produced by an industrial process selected from the group consisting of hydraulic fracturing (fracking), crude oil production from oil sand, steam-assisted gravity drainage (SAGD), petroleum industry processing, enhanced oil recovery (EOR) and vegetable oil production.

Alternatively or additionally, in some embodiments the wastewater stream is produced by an industrial process selected from the group consisting of recovering crude oil and processing crude oil.

Alternatively or additionally, in some embodiments the method includes contacting crude oil with the separated water to produce the wastewater stream.

Alternatively or additionally, in some embodiments the bi-directional solvent includes one or more oxygen-comprising organic molecules with 3 to 6 carbon atoms.

Alternatively or additionally, in some embodiments the bi-directional solvent includes one or more members of the group consisting of alcohols, ketones, esters, phenols and organic acids.

Alternatively or additionally, in some embodiments the bi-directional solvent includes one or more members of the group consisting of normal butanol, secondary butanol, isobutanol, tertiary butanol, normal pentanol, secondary pentanol, isopentanol and tertiary pentanol

Alternatively or additionally, in some embodiments the bidirectional solvent is selected so that the ratio of the one or more hydrophilic solutes to the one or more crude-oil-associated hydrophobic solutes is at least ten times higher in the water-depleted first aqueous solution than in the wastewater stream.

Alternatively or additionally, in some embodiments the concentration of at least one of the one or more crude-oil-associated hydrophobic solutes in the extractant is at least three times higher than the concentration of the at least one of the one or more crude-oil-associated hydrophobic solutes in the wastewater stream just prior to the first contacting.

Alternatively or additionally, in some embodiments the separating at least a portion of the one or more crude-oil-associated hydrophobic solutes from the second organic phase includes evaporation.

Alternatively or additionally, in some embodiments the method includes conducting the first contacting, the second contacting or both in a counter current mode.

Alternatively or additionally, in some embodiments between 2 and 20 weight units of the bi-directional solvent are provided for each weight unit of water in the wastewater stream at the first contacting.

Alternatively or additionally, in some embodiments the bi-directional solvent includes one or more phenols.

Alternatively or additionally, in some embodiments the one or more crude-oil-associated hydrophobic solutes include one or more oils.

In some exemplary embodiments of the invention, there is provided a system including:

(a) a wastewater source producing a wastewater stream comprising one or more hydrophilic solutes;

(b) an extractant source comprising an extractant including a bi-directional solvent;

(c) a first extraction module in fluid communication with the extractant source and adapted to contact the extractant with at least a portion of the wastewater stream to form a water-depleted first aqueous solution and a water-enriched first organic phase;

(d) a second extraction module adapted to receive the first organic phase and contact the first organic phase with a concentrated aqueous solution, to produce a second organic phase and a second aqueous solution;

(e) a separation module adapted to separate water and a solute from the second aqueous solution; and

(f) a pump adapted to route at least a portion of the solute to the second water extraction module as recycled aqueous solution.

Alternatively or additionally, in some embodiments the system includes a solvent pump directing at least a portion of the second organic phase to the first water extraction module.

It will be appreciated that the various aspects described above relate to solution of technical problems associated with production of usable water and/or recycling of water in an industrial process.

Alternatively or additionally, it will be appreciated that the various aspects described above relate to solution of technical problems related to conservation of energy in water purification processes.

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

As used herein, the terms “comprising” and “including” or grammatical variants thereof are to be taken as specifying inclusion of the stated features, integers, actions or components without precluding the addition of one or more additional features, integers, actions, components or groups thereof. This term is broader than, and includes the terms “consisting of” and “consisting essentially of” as defined by the Manual of Patent Examination Procedure of the United States Patent and Trademark Office.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

The phrase “adapted to” as used in this specification and the accompanying claims imposes additional structural limitations on a previously recited component.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

Percentages (%) of chemicals and/or contaminants are W/W (weight per weight) unless otherwise indicated. Percentages of solute in solvent (solute concentration) are W/W. In those cases where a portion of a solute precipitates or crystallizes, the weight of solid solute and dissolved solute are both considered in calculating the solute concentration.

As used herein, “a proportion of”, “a concentration of” or “a ratio between” “hydrophobic solute”, “one or more hydrophobic solute”, “at least one of said one or more hydrophobic solute”, “hydrophilic solute”, “one or more hydrophilic solute”, “at least one of said one or more hydrophilic solute”, “monovalent”, “at least one monovalent ion”, “multivalent”, “at least one multivalent ion” and similar phrases are to be taken as specifying a proportion of or a concentration of at least one solute/ion, or the ratio between concentration of a single solute/ion and the concentration of another single solute/ion.

### BRIEF DESCRIPTION OF THE DRAWINGS

In order to understand the invention and to see how it may be carried out in practice, embodiments will now be described, by way of non-limiting example only, with reference to the accompanying figures. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1 is a schematic flow plan of a water recovery process according to an exemplary embodiment of the invention depicting procedures and streams;

FIG. 2 is a schematic flow plan of a water recovery process according to an exemplary embodiment of the invention depicting procedures and streams;

FIG. 3 is a schematic flow plan of a water recovery process according to an exemplary embodiment of the invention depicting procedures and streams; and

FIG. 4 is a schematic representation of a water recovery system according to some exemplary embodiments of the invention.

### DETAILED DESCRIPTION OF EMBODIMENTS

Embodiments of the invention relate to methods and systems for water recovery as well as to various streams produced by the recovery process.

Specifically, some embodiments of the invention can be used to recover wastewater from product process water in an industrial process.

The principles and operation of a methods and/or systems according to exemplary embodiments of the invention may be better understood with reference to the drawings and accompanying descriptions.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of description and should not be regarded as limiting.

### Exemplary Water Recovery Processes Overview

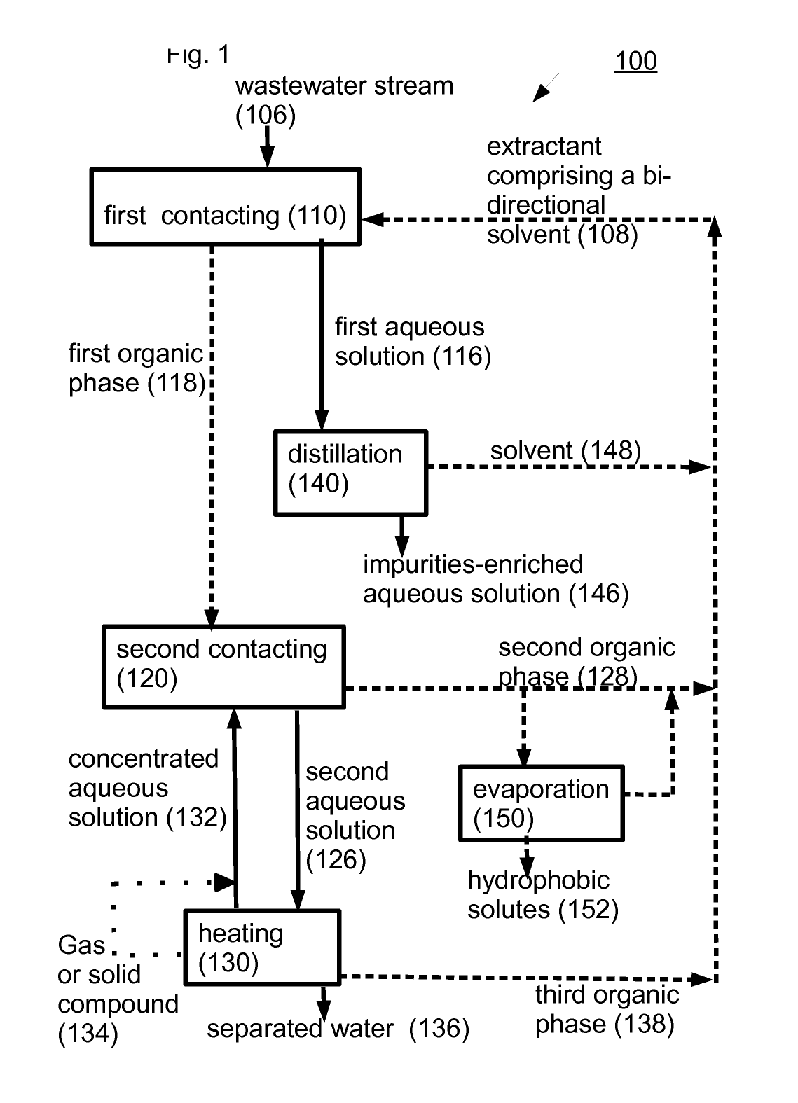

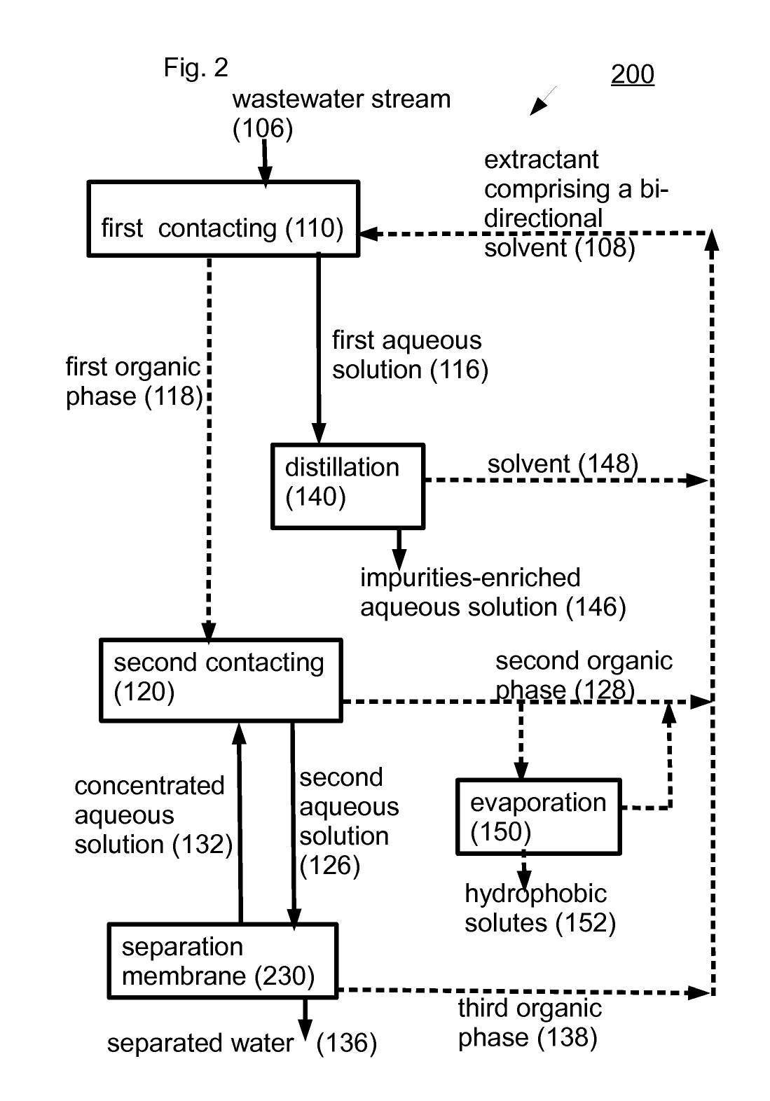

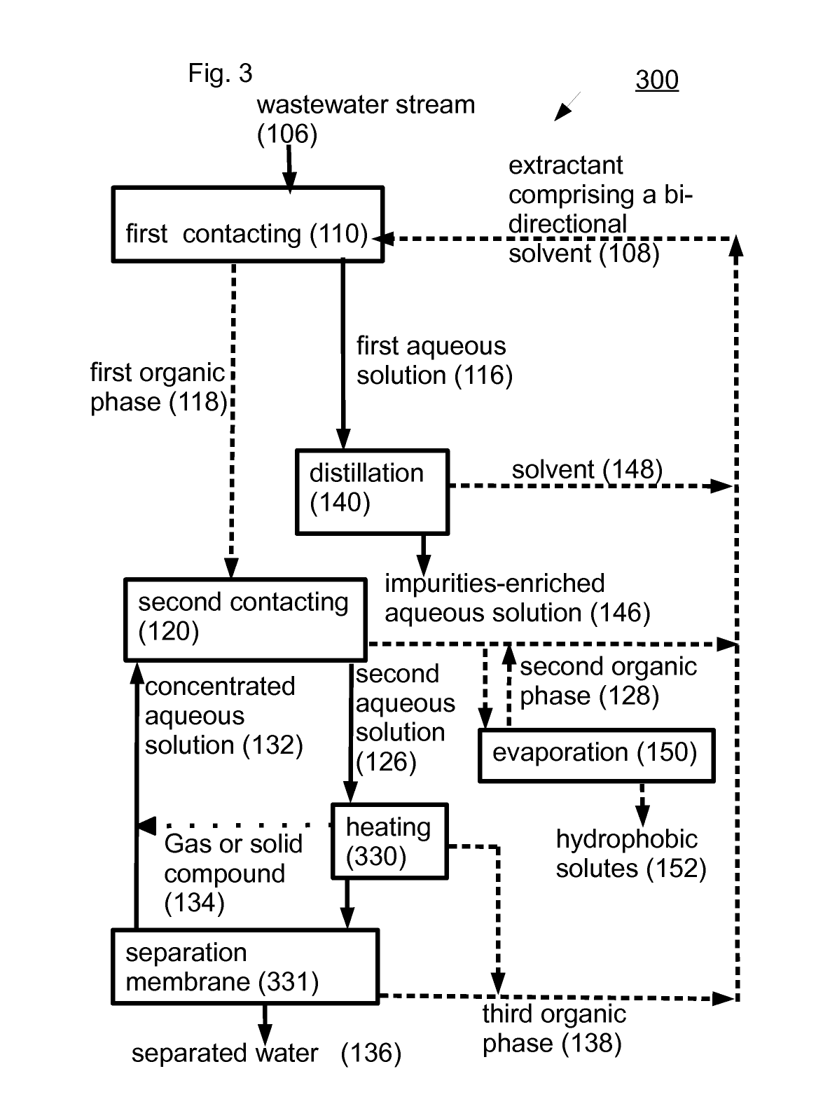

FIG. 1, FIG. 2 and FIG. 3 are a schematic flow plan of a water recovery process or methods according to an exemplary embodiments of the invention indicated generally as 100, 200 or 300 respectively.

In the figures, a flow of organic phases is depicted by dashed arrows, a flow of aqueous solutions is depicted by solid arrows and a flow of gas or solid compound is depicted by dot arrows.

In the depicted exemplary embodiments, at least a portion of a wastewater stream containing one or more hydrophilic solutes 106 is first contacted 110 with an extractant 108 including a bi-directional solvent to form a water-depleted first aqueous solution 116 and a water-enriched first organic phase 118.

In the depicted exemplary embodiments, the first organic phase 118 is second contacted with a concentrated aqueous solution 132 to form a second organic phase 128 and a second aqueous solution 126.

In the depicted exemplary embodiment 100 (FIG. 1), water is separated from the second aqueous solution 126 (e.g. by heating 130) to form a gas or solid compounds 134 and separated water 136.

In the depicted exemplary embodiment 100 (FIG. 1), gas or solid compounds 134 are contacted with a third aqueous solution to form a concentrated aqueous solution 1321. n the depicted exemplary embodiment 200 (FIG. 2), water is separated from the second aqueous solution 126 (e.g. by Reverse Osmosis 230) to form a concentrated aqueous solution 132 and separated water 136.

In the depicted exemplary embodiment 300 (FIG. 3), gas or solid compounds 134 are separated from the second aqueous solution 126 (e.g. by heating 330) and water is separated from the second aqueous solution 126 (e.g. by Reverse Osmosis 331) to form a concentrated aqueous solution 132 and separated water 136.

In the depicted exemplary embodiments, the concentrated aqueous solution 132 is recycled to the second contacting 120.

In the depicted exemplary embodiments, bi-directional solvent is recycled from the second organic phase 128 to the first contacting 110.

In some exemplary embodiments of the invention, water partial vapor pressure at 50° C. of the wastewater stream 106, the water-depleted first aqueous solution 116, the recycled aqueous solution 132 and the second aqueous solution 126 are P1, P2, P3 and P4, respectively; wherein P1>P2; P1>P3 and P4>P3. According to some embodiments, P2>P3 and/or P1>P4.

According to some embodiments of the invention, the second contacting 120 is conducted between concentrated aqueous solution 132 and at least a fraction of first organic phase 118.

In some exemplary embodiments of the invention, the wastewater stream 106 comprises one or more crude-oil-associated hydrophobic solutes. According to various embodiments of the invention, at least a portion of the one or more crude-oil-associated hydrophobic solutes is separated from a portion of the second organic phase 128 (in the depicted exemplary embodiments, by evaporation 150). According to an embodiment, the separating hydrophobic solutes 152 is conducted prior to the recycling of bi-directional solvent from the second organic phase 128 to the first contacting 110 or simultaneously with it.

In some exemplary embodiments of the invention, first aqueous solution 116 is substantially free of organic compounds (crude-oil-associated hydrophobic solutes) other than the bi-directional solvent. These organic compounds (if present) tend to migrate into first organic phase 118. As described below, additional separations by evaporation lead to regeneration of the bi-directional solvent and (optionally) to recovery of desired organic compounds.

Depicted exemplary embodiments 100, 200 and 300 employs distillation 140 to recover bi-directional solvent 148 dissolved in first aqueous phase 116. In other exemplary embodiments of the invention other separation methods are employed, e.g. salting out or using an auxiliary solvent. The amount of solvent 148 to be distilled is relatively small because the majority of bi-directional solvent from extractant 108 is present in first organic phase 118. In some embodiments, solvent 148 distills as an azeotrope with water. Optionally, water in solvent 148 contributes to an increased total water yield as extractant stream 108 is recycled.

In the depicted exemplary embodiments, distillation 140 also produces an impurities-enriched aqueous solution 146. According to an embodiment, said impurities-enriched solution is characterized by water partial vapor pressure at 50° C. of P5 and P5>P1. According to various embodiments, said impurities-enriched solution is disposed as such or after further treatment. According to various embodiments, such further treatment comprises at least one of further concentration, precipitation of at least one component and addition of a chemical compound. According to various embodiments the flow rate of said wastewater is F1, the flow rate of said impurities-enriched solution is F2 and F1/F2 is greater than 2, 4, 6, 8, 10 or intermediate of greater ratio.

In the depicted exemplary embodiments, second organic phase 128 (containing some water) is recycled to extractant stream 108 without further separation of water.

Separated water 136 is the primary product of methods 100, 200 and 300. In some exemplary embodiments of the invention, the amounts of bi-directional solvent and/or hydrophilic solutes and/or hydrophobic solutes in separated water 136 are sufficiently low at this stage that it can serve as feed water to an industrial process and/or agricultural irrigation water and/or potable water.

In some exemplary embodiments of the invention, wastewater stream 106 contains one or more crude-oil-associated hydrophobic solutes. These hydrophobic solutes migrate to the bi-directional solvent and will tend to accumulate there if not removed. In the depicted exemplary embodiments, evaporation 150 is depicted as separating at least a portion of the one or more hydrophobic solutes 152 from second organic phase 128 prior to the contacting with wastewater stream 106. In some embodiments, hydrophobic solutes 152 include organic acids (e.g. naphthenic acid).

According to various embodiments, water separating from second aqueous solution 126 includes at least one of Heating, Evaporation, Reverse Osmosis, Forward Osmosis, Electrodialysis and contacting with a solvent.

In some exemplary embodiments 200 (FIG. 2) and 300 (FIG. 3) of the invention, the separating of water from second aqueous solution 126 includes contacting the second aqueous solution 126 with a membrane 230 (FIG. 2) or 331 (FIG. 3) to form a separated water 136 and a retentate which includes the concentrated aqueous solution 132. In the depicted exemplary embodiments, the membrane is a reverse osmosis membrane (RO). In other exemplary embodiments, the membrane is a nano-filtration membrane.

According to some embodiments, second aqueous phase 126 includes the bi-directional solvent. The concentration of the bi-directional solvent in second aqueous phase 126 is a function of hydrophilic solutes (e.g. salts) concentration there. According to some embodiments 200 (FIG. 2) and 300 (FIG. 3), the bi-directional solvent is at least partially removed from the second aqueous solution 126 prior to the contacting with the membrane (depicted as separation membrane 230 (FIG. 2), or 331 (FIG. 3)), e.g. by distillation. Alternatively or additionally, according to some embodiments the bi-directional solvent is separated by the contacting with a membrane (e.g. separation membrane 230 (FIG. 2), or 331 (FIG. 3)). According to an embodiment, the bi-directional solvent is rejected by the membrane and is retained in the retentate along with the concentrated aqueous solution. According to an embodiment, said concentrated aqueous solution 132 is of reduced volume and higher salt concentration compared to said second aqueous solution. As a result, the amount of bi-directional solvent dissolved in it is small compared with the amount dissolved in said second aqueous solution and the vast majority of the bi-directional solvent is rejected to a third organic phase 138, which is formed in the retentate.

In some embodiments, at least a portion of the third organic phase 138 is recycled as bi-directional solvent to the first contacting 110. According to various embodiments, said third organic phase 138 is combined with said second organic phase 128 or introduced separately to said first contacting, e.g. at a point closer to the exit of said first aqueous solution 116.

In some embodiments, the retentate is included in the concentrated aqueous solution which is at least partially recycled to the second contacting 120 as concentrated aqueous solution 132. According to a related embodiment, the recycling to the second contacting 120 is conducted without prior separation of dissolved bi-directional solvent.

In some embodiments, the separated water 136 comprises at least 60%, 70%, 80%, 85%, 90% or at least 95% of the water in the wastewater stream 106.

According to various embodiments, the third organic phase 138 includes the bi-directional solvent and water. According to an embodiment, the third organic phase 138 could be recycled as such to the first contacting in 110.

According to various embodiments, water extraction (first contacting 110) is selective to water over ions. Selectivity is particularly high compared to extraction of divalent ions, including ones contributing to hardness and scale.

According to some embodiments, wastewater stream 106 includes at least one multivalent ion and at least one monovalent ion at a multivalent to monovalent ratio R1, the first aqueous solution 116 includes at least one multivalent ion and at least one monovalent ion at a multivalent to monovalent ratio R2, and R2 is similar to R1. According to some embodiments, R2/R1 is in the range between 0.75 and 1.25, between 0.8 and 1.2, between 0.85 and 1.15 or between 0.9 and 1.1.

According to some embodiments, the concentrated aqueous solution 132 includes at least one multivalent ion and at least one monovalent ion at a multivalent to monovalent ratio R3, and R3>R1. According to some embodiments, R3/R1 is greater than 2, 4, 6, 8 or greater than 10.

According to some embodiments, both the wastewater stream 106 and the concentrated aqueous solution 132 include at least one multivalent ion, and the composition of multivalent ions in the wastewater stream 106 is different from the composition of multivalent ions in the concentrated aqueous solution 132. According to various embodiments, one of these solutions (132 and 106) contains at least one multivalent ions that do not exist in the other. Alternatively or additionally, in some embodiments the concentration of a given multivalent ion in one of these solutions is different from the concentration of the same multivalent ion in the other.

### Exemplary Water Separation Method

In some exemplary embodiments 100 (FIG. 1) and 300 (FIG. 3) of the invention, the concentrated aqueous solution 132 contains at least one member of: NH₃, CO, CO₂, CaCl2, Ca(NO2)3, KBr, KCl, KHCO3, K2SO4, MgCl2, MgSO4, NaCl, NaHCO3, Na2SO4, NH4Cl, (NH₄)₂CO₃, (NH₄)HCO₃, H₂NCOONH₄ and (NH4)2SO4. At the second contacting 120 said concentrated aqueous solution 132 and said first organic phase are contact, generating second organic phase 128 and second aqueous solution 126.

According to exemplary embodiment 100 (FIG. 1) The heating 130 of the second aqueous solution 126 generate the following streams; third organic phase 138, solid or gas compounds 134, a third aqueous solution and separated water 136. Contacting said third aqueous solution with said solid or gas compound reforms said concentrated aqueous solution 132.

According to exemplary embodiment 300 (FIG. 3) the secondary aqueous solution 126 is heated 330 to separate a solid and/or gas compound 134. According to exemplary embodiments, the separated compound is selected from a group consisting of NH₃, CO, CO₂, CaCl2, Ca(NO2)3, KBr, KCl, KHCO3, K2SO4, MgCl2, MgSO4, NaCl, NaHCO3, Na2SO4, NH4Cl, (NH₄)₂CO₃, (NH₄)HCO₃, H₂NCOONH₄ and (NH4)2SO4. The formed aqueous solution is contacted with a membrane, e.g. a reverse osmosis membrane, to form a retentate, separated water 136 and a fourth organic phase.

According to an exemplary embodiment, said separated solid and/or gaseous compound is contacted with said retentate to reform said concentrated aqueous solution 132.

According to some embodiments the concentrated aqueous solution 132 comprises an ammonium compound. The ammonium compound includes at least one of ammonium bicarbonate, ammonium carbonate, and ammonium carbamate.

### Exemplary Water Recovery Method

Alternatively or additionally, in some embodiments, methods 100, 200 and 300 includes contacting (not depicted) at least a fraction of at least one of first organic phase 118 and second organic phase 128 with a hydrophobic solvent, characterized in that C:O ratio in the hydrophobic solvent is at least 2 times greater than that ratio in the bi-directional solvent. According to these embodiments, the contacting induces water rejection from the first organic phase 118 and/or the second organic phase 128. According to various embodiments, after separating the rejected water, the hydrophobic solvent is separated (e.g. by distillation of one of the two) from the bi-directional solvent in first organic phase 118 and/or second organic phase 128 before the solvent is reused in the contacting 120 and/or 110, respectively.

### Various Exemplary Embodiments

According to various exemplary embodiments of the invention crude-oil-associated hydrophobic solutes 152 include naphthenic acid and/or other organic acids comprising at least 5 carbons, and/or 1,4-dioxane, and/or acetone, and/or bromoform, and/or dibenzo(a,h)anthracene, and/or pyridine, and/or phenols and/or oil (e.g. fossil oil, vegetable oil). According to some embodiments, in addition to soluble crude-oil-associated hydrophobic matter, there could be suspended crude-oil-associated hydrophobic matter. Therefore, the amount of the crude-oil-associated hydrophobic matter in 106 may be greater than saturation concentration.

According to some embodiments, one or more of the crude-oil-associated hydrophobic solutes is less volatile than water, and is difficult to separate from the wastewater stream 106 by known methods, such as evaporation. According to some embodiments of the invention, such solutes are efficiently removed at low cost, optionally without their evaporation.

In some embodiments, second organic phase 128 includes at least 85%, at least 90%, at least 95%, at least 97.5% or at least 99% of the at least one of the one or more crude-oil-associated hydrophobic solutes which were present in the wastewater 106. Alternatively or additionally, in some embodiments water-depleted first aqueous solution 116 includes at least 80%, at least 85%, at least 90%, at least 95%, at least 97.5% or at least 99% of the at least one of the one or more hydrophilic solutes (i.e. in case of multiple solutes, this could be true for one of the solutes in some embodiments and more than one of them in other embodiments) in the wastewater stream 106.

In some exemplary embodiments of the invention, the method includes recycling at least 50%, at least 55%, at least 65%, at least 70%, at least 75%, at least 80%, at least 85%, at least 90% or at least 95% of water from the wastewater stream 106 to an industrial process producing the wastewater stream. According to some embodiments, the recycled water is derived from the second aqueous solution 126. According to other embodiments, the recycled water includes the separated water 136 from the heating 130 (FIG. 1) or Separation membrane 230 (FIG. 2) or 331 (FIG. 3). According to some embodiments, the industrial process generates different “product process water” stream (i.e. wastewater stream) and/or consumes water/aqueous solutions in multiple steps. According to some embodiments, the recycled water results from any stream and is used in any step. According to some embodiments, the recycled water is at high quality. According to some exemplary embodiments, the recycled water is at quality as required for steam production (including steam required for stripping solvent from exiting streams). Alternatively or additionally, according to some embodiments, the water derived from the second aqueous solution 126 and/or from separated water 136 has alternative outlets (e.g. irrigation, emission to rivers and sewage).

According to various exemplary embodiments of the invention the wastewater stream 106 is produced by an industrial process selected from the group consisting of induced hydraulic fracturing (fracking), Steam Assisted Gravity drainage (SAGD), crude oil production from oil sand, petroleum industry processing, enhanced oil recovery (EOR) and vegetable oil production. In some exemplary embodiments of the invention, wastewater stream 106 is produced by an industrial process selected from the group consisting of recovering crude oil, recovering gas, and processing crude oil.

In some exemplary embodiments of the invention, methods 100, 200 and 300 includes contacting crude oil with separated water 136 derived from second aqueous solution 126 to produce the wastewater stream 106.

According to various exemplary embodiments of the invention, the bi-directional solvent in extractant 108 includes one or more organic molecules with 3 to 6 carbon atoms. In some embodiments, the organic molecules include alcohols and/or ketones and/or esters and/or organic acids. In some embodiments, the bi-directional solvent in extractant 108 includes a butanol (e.g. n-butanol or isobutanol). Alternatively or additionally, in some embodiments the bi-directional solvent in extractant 108 comprises one or more amines. According to some embodiments, the one or more amines include one or more members of the group consisting of diethylamine, triethylamine, 1-methyl piperidine, 4-methyl piperidine di-isopropylamine, N,N-dietheylmethylamine, dimethylisopropylamine, ethylisopropylamine, methylethylisopropylamine, methylethyl-n-propylamine, dimethyl-secondary-butylamine, dimethyl-tertiary-butylamine, dimethylisobutylamine, dimethyl-n-butylamine, methyldiethylamine, dimethylallylamine, dimethyl-n-propylamine, diisopropylamine, di-n-propyl amine, di-allylamine, n-methyl-n-amylamine, n-ethyl-n-butylamine, n-ethyl-sec-butylamine, n-ethyl-tertiary-butylamine, n-ethyl-n-propylamine, n-ethyl-isopropylamine, n-methyl-n-butylamine, n-methyl-sec-butylamine, n-methyl-iso-butylamine, n-methyl-tertiary butylamine, dimethyl, 1,1-dimethylpropylamine and dimethyl, 1-methyl butylamine.

In some exemplary embodiments of the invention, a single amine is employed. In other exemplary embodiments of the invention, a combination of two or more amines is employed. Alternatively or additionally, amines are used in combination with non-amine molecules in some embodiments of the invention.

In some exemplary embodiments of the invention, the ratio of at least one of the hydrophilic solutes to at least one of the crude-oil-associated hydrophobic solutes is at least ten times higher (this ratio does not necessarily apply to the ratio between total hydrophilic solutes and total hydrophobic solutes) in the water-depleted first aqueous solution 116 than in the wastewater stream 106. Alternatively or additionally, in some embodiments of the invention, the concentration of at least one of the one or more crude-oil-associated hydrophobic solutes in extractant 108 is at least three times higher than the concentration of the at least one of the one or more crude-oil-associated hydrophobic solutes in the wastewater stream 106 just prior to first contacting 110 (this ratio does not necessarily apply to the total hydrophobic solutes).

Again, in the depicted exemplary embodiment, separating at least a portion of the one or more crude-oil-associated hydrophobic solutes 152 from second organic phase 128 includes evaporation 150. In some exemplary embodiments of the invention, evaporation 150 includes distillation of the solvent from solutes 152. According to some embodiments, the hydrophobic solute is more volatile than the bi-directional solvent. In that case, the solute is evaporated out. In other cases, the opposite is true and the bi-directional solvent is evaporated. Still there could be both solutes that are more volatile than the bi-directional solvent and ones that are less volatile. In such cases, the more volatile are evaporated first and then the bi-directional solvent is evaporated. According to an embodiment, only a small fraction of the second organic phase 128 is treated for separation of the hydrophobic solutes 152, e.g. less than 20% of it, less than 15%, less than 10%, or less than 5%.

In some embodiments the one or more crude-oil-associated hydrophobic solutes include one or more phenols. Alternatively or additionally, in some embodiments the one or more crude-oil-associated hydrophobic solutes include one or more oils (e.g. fossil oil, vegetable oil).

In some embodiments, the method includes conducting first contacting 110 and/or second contacting 120 in a counter current mode. According to some embodiments, the contacting 110 and/or 120 is conducted in 2-20 stages, 3-15 stages, 4-12 stages or 5-10 stages.

Alternatively or additionally, in some embodiments of methods 100, 200 and 300 the weight/weight ratio between the amount of bi-directional solvent in stream 108 and the amount of water in stream 106 is in a range between 2:1 and 20:1, between 3:1 to 17:1, between 6:1 to 15:1, between 2:1 and 12:1, between 3:1 and 11:1, between 4:1 and 10:1 or in a range between 8:1 to 12:1. According to some embodiments, first contacting 110 is conducted in a continuous mode and this ratio is between the weight fluxes of streams instead of the amounts.

In some embodiments, stream 106 contains suspended solids. These solids can include, but are not limited to sand or soil particles. According to various embodiments, these solids are removed prior to the first contacting 110. According to various exemplary embodiments of the invention solids removal module includes a settling tank and/or filtration equipment and/or centrifugation equipment (e.g. a flow through centrifuge and/or a cyclonic separator). In some embodiments, removal of solids contributes to mechanical efficiency of downstream processes.

Alternatively or additionally, in some embodiments stream 106 contains one or more dissolved surfactants (e.g. soaps and/or detergents). According to various embodiments, at least one of the one or more surfactants is removed from and/or inactivated in at least a portion of stream 106 prior to first contacting 110. In some embodiments, a surfactant removal and/or inactivation module is positioned upstream of the first contacting 110 to reduce activity of surfactants present in stream 106. According to various exemplary embodiments of the invention the surfactant removal and/or inactivation module employs surface active material (e.g. activated charcoal) and/or pH adjustment and/or addition of multivalent ions.

In some exemplary embodiments of the invention, the surfactant removal and/or inactivation module contributes to an efficiency of separation of first aqueous solution 116 from first organic phase 118 and/or to an efficiency of separation of second aqueous solution 126 from second organic phase 128.

### Exemplary Wastewater Compositions

In some exemplary embodiments of the invention, wastewater stream 106 contains at least 10,000 PPM; at least 20,000 PPM; at least 30,000 PPM or at least 40,000 PPM of total dissolved solids (TDS). In other exemplary embodiments of the invention, stream 106 contains less than 100,000 PPM, less than 90,000 PPM, less than 80,000 PPM, less than 70,000 PPM or less than 50,000 PPM of total dissolved solids (TDS).

In various exemplary embodiments of the invention, total dissolved solids (TDS) in said wastewater stream 106 is less than 10,000 ppm; less than 8,000 ppm; less than 6,000 ppm; less than 4,000 ppm or less than 2,000 ppm. Wastewater stream with these relatively low levels of TDS is produced, for example, in cooling towers and/or in the oil industry.

Alternatively or additionally, in some embodiments the TDS includes barium and/or strontium and/or iron and/or other heavy metals and/or radioactive isotopes and/or cyanides and/or thiocyanates and/or salts of ammonia and/or sulfides and/or sulfates and/or calcium salts and/or silica.

### Exemplary Extraction Conditions

Various exemplary embodiments of the invention described herein relate to extraction (110) of water into an extractant comprising bi-directional solvent or back-extraction (120) of water from such extractant. According to various embodiments, at least one of such extraction and back-extraction is conducted by contacting in a multiple step, counter-current operation. According to various embodiments, such contacting is conducted in industrially used contactors, e.g. mixer-settlers, extraction columns, centrifugal contactors and raining-bucket contactor. According to an embodiment, the wastewater comprises suspended solids and/or solids are formed during said first contacting and the used contactor is designed to handle such solids.

### Exemplary Optional Treatment of Said First Organic Phase

In some exemplary embodiments of the invention, first organic phase 118 is treated prior to said second contacting, e.g. by adding an organic solvent or contacting with an aqueous solution. According to another embodiment, first organic phase 118 comprises suspended solids and said treating prior to said second contacting comprises separating such suspended solids, e.g. via extended settling or addition of a coagulant.

### Exemplary Solvent Considerations

According to various exemplary embodiments of the invention the bi-directional solvent employed in extractant stream 108 is selected based upon the total dissolved solids (TDS) content of stream 106 and/or the organic compounds (e.g. hydrophobic solutes) content of stream 106 and the cost of available energy.

### Exemplary Advantages

A known method for treating wastewater involves evaporation of the water. Energy consumption is high due to the required input of latent heat. Major efforts are directed to developing alternatives based on membrane separation (e.g. Reverse Osmosis). Those require several pretreatments (e.g. filtration, adsorption, coagulation and softening) in order to protect the membrane. These pretreatments substantially increase the cost of the membranes-based separation.

One exemplary advantage of some embodiments of the invention is that water is separated by the extraction with a bi-directional solvent and recovered from the formed organic phase without the input of latent heat.

Alternatively or additionally, another exemplary advantage of some embodiments of the invention is that the separation membrane 230 (FIG. 2) and 331 (FIG. 3) is not directly contacted with the wastewater stream; therefore less pretreatment stages are required.

Alternatively or additionally, those portions of the process that optionally employ latent heat (e.g. distillation 140) are applied to smaller portions of the total mass in the system and directed to evaporation of relatively low latent heat solvent, resulting in significant energy savings.

Alternatively or additionally, exemplary methods 100, 200 and 300 achieves efficient separation of usable water (separated water 136) from the wastewater (106) forming a reduced-volume, impurities-concentrated stream (impurities-enriched aqueous solution 146), thereby reducing the volume of wastewater to disposal.

Alternatively or additionally, exemplary methods 100, 200 and 300 achieves good separation of organic matter (hydrophobic solutes 152), which can be used for energy or more specific application.

Alternatively or additionally, exemplary methods 100,200 and 300 results in a high quality separated water 136, which may be used e.g. for steam, in a relatively low costs compared to alternative treatments.

Alternatively or additionally, exemplary methods described herein are more suitable for use in handling hard water (at 106) than previously available alternatives.

Alternatively or additionally, exemplary methods described herein contribute to a reduction in use of chemical reagents.

Alternatively or additionally, exemplary methods described herein are amenable to integration with other methods, e.g. gravity separation devices such as the API (American Petroleum Institute) oil-water separator.

### Exemplary System

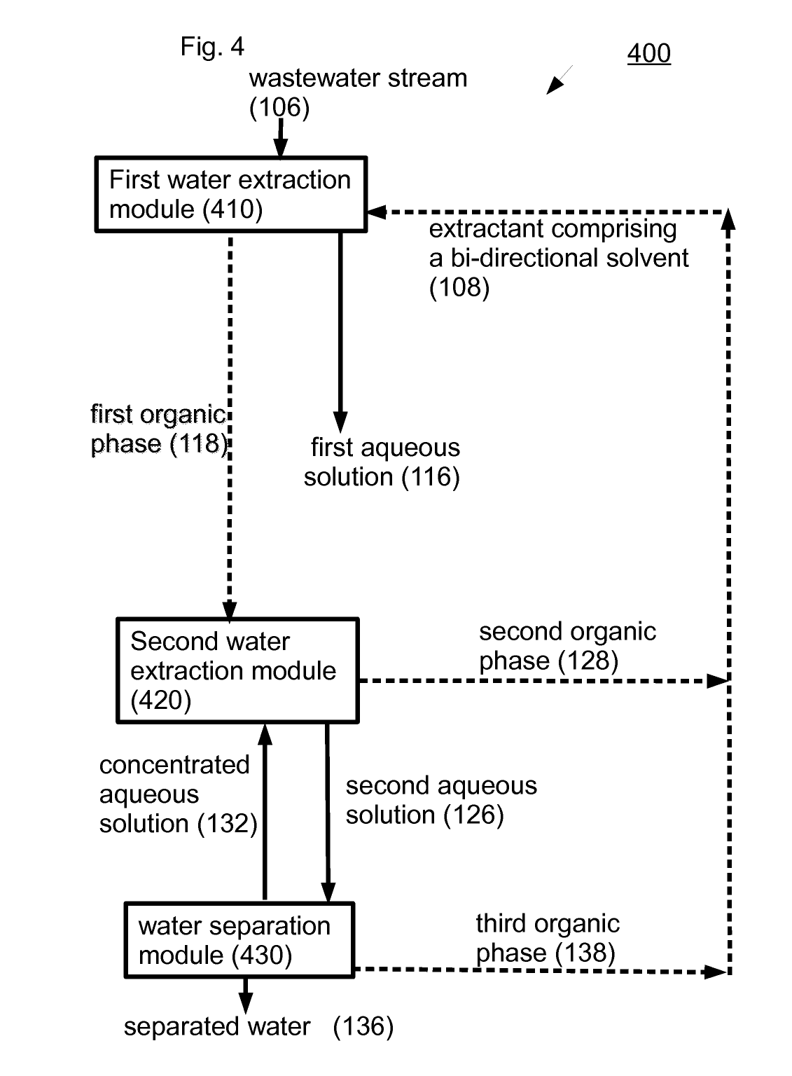

FIG. 4 is a schematic representation of a water recovery system indicated generally as 400. In the figure, a flow of organic phases is depicted by dashed arrows, and a flow of aqueous solutions is depicted by solid arrows. Numbers which appear in FIGS. 1, 2 and 3 and are used in FIG. 4 to indicate flows similar to those described above.

Depicted exemplary system 400 includes a first water extraction module 410 adapted to contact an extractant comprising a bi-directional solvent 108 with at least a portion of a wastewater stream including one or more hydrophilic solutes 106 to form a water-depleted first aqueous solution 116 and a water-enriched first organic phase 118.

In the depicted exemplary embodiment, system 400 includes a second water extraction module 420 adapted to contact the first organic phase 118 with a concentrated aqueous solution 132, to produce a second organic phase 128 and a second aqueous solution 126.

Depicted exemplary system 400 also includes a separation module 430 adapted to separate a concentrated aqueous solution 132, third organic phase 138 and separated water 136 from the second aqueous solution 126.

According to various embodiments of the invention, the first contacting 110 at the first water extraction module 410 occurs at a first temperature (T1) and the second contacting 120 at the second water extraction module 420 occurs at a second temperature (T2). According to some embodiments T2 is similar to T1. According to other embodiments, T2 is different than T1.

According to various embodiments of the invention, system 400 is configured to allow recycling of at least a portion of the concentrated aqueous solution to the second water extraction module 420. In the depicted exemplary system, at least a portion of the concentrated aqueous solution 132 is recycled to the second water extraction module 420.

According to various embodiments of the invention, system 400 is configured to allow recycling of at least a portion of the second organic phase 128 as bi-directional solvent to the first water extraction module 410.

According to some embodiments of the invention, the separation module comprises a membrane adapted to form separated water 136 and a retentate in a retentate compartment and the retentate is included in the concentrated aqueous solution 132. In the depicted exemplary system, the membrane is a Reverse Osmosis membrane.

According to some embodiments of the invention, the system is characterized in that the second aqueous solution 126 includes the bi-directional solvent and in that the retentate compartment is adapted to include a third organic phase 138.

According to various embodiments of the invention, system 400 is configured to allow recycling of at least a portion of the third organic phase 138 as bi-directional solvent to the first water extraction module 410.

According to various embodiments of the invention, system 400 is characterized in being portable. According to some embodiments, system 400 is mobile, moveable, and can be transported from one place to another (e.g. from one shale oil play to another). According to an embodiment, system 400 is skid mounted.

### Exemplary Use Scenario I: Induced Hydraulic Fracturing (Fracking)

A typical fracking well requires between 4,000 m³ and over 22,000 m³ of water. Waste water produced by fracking contains hydrophilic solutes including but not limited to sodium, magnesium and calcium salts, barium, strontium, iron, other heavy metals and radioactive isotopes. Total dissolved solids (TDS) are typically in the range of 5,000 PPM to 100,000 PPM or more.

Waste water produced by fracking also contains hydrophobic materials such as oil.

Referring again to FIGS. 1, 2, 3 and 4: in some exemplary embodiments of the invention, fracking serves as industrial process and flowback and/or produced water serve as wastewater stream 106.

During water recovery processes 100, 200 and 300 the bulk of the hydrophilic solutes will separate into first aqueous solution 116 and according to some embodiments, be removed from the system at 146 as described in detail hereinabove.

The hydrophobic solutes are selectively and efficiently extracted into the first organic phase 118 in the first contacting 110. The hydrophobic solutes remain practically fully in the extractant during the second contacting, i.e. in the second organic phase 128. In the depicted exemplary embodiments of FIGS. 1, 2 and 3 a fraction of the hydrophobic solutes arrive at evaporation 150 and is at least partially removed from the system at 152. Separated water 136 becomes feed process water to the industrial process and can be used as part of input water for a subsequent round of fracking

In some cases, waste water produced by fracking contains a surfactant. Optionally, surfactant is removed prior to introduction into methods 100, 200 and 300. In some exemplary embodiments of the invention, removal of surfactant contributes to a more efficient partitioning between organic phases and aqueous solutions throughout the process.

Exemplary Use Scenario II: Synthetic Crude Oil from Oil Sands

Production of a barrel of synthetic crude oil from oil sand requires about 2 to 4.5 barrels of fresh water as an input. In the conventional subterranean process, this water is applied as steam to oil sand in a well. In the Surface mining, the oil sand is removed from the well and then the water is applied.

In the Steam Assisted Gravity Drainage (SAGD) process two horizontal wells are drilled in the oil sands, one at the bottom of the formation and another about 5 metres above it. These wells are typically drilled in groups off central pads and can extend for miles in all directions. In each well pair, steam is injected into the upper well, the heat melts the bitumen, which allows it to flow into the lower well, where it is pumped to the surface.

The steam for the SAGD process can be generated by a once-through steam generator (OTSG). The feed for the OTSG can comprise produced water and optionally also make-up water. The OTSG generate a high quality steam for the well injection and a blowdown stream that can contain dissolve solids, the blowdown stream needs treatment. The produced Synthetic Crude Oil contain water (produces water) that are separated during the processing of the Synthetic Crude Oil, Separated water is recycled to the steam generator.

During the Synthetic Crude Oil production portion of the injected steam remains in the ground formation and does not return as produce water. To stand the amount of steam required to the Synthetic Crude Oil production make-up water is used in addition to the recycled separated produce water.

Make-up water is provided from natural sources as rivers or underground wells in some cases the make-up water contains inorganic salts (hydrophilic solutes).

Removal of the inorganic salts and organic acids prior to the OTSG can decrease the inorganic salts and organic acids percentage in the blewdown water.

In some exemplary embodiments of the invention produce water (with or without mixing with make-up water) and blowdown water are wastewater produced during production of synthetic crude oil.

Waste water produced during production of synthetic crude oil contains inorganic salts (hydrophilic solutes), and organic acids (hydrophobic solutes).

Referring again to FIGS. 1, 2, 3 and 4: in some exemplary embodiments of the invention, production of synthetic crude oil serves as industrial process and wastewater produced during production of synthetic crude oil serves as wastewater stream 106.

During water recovery process 100, 200 or 300 the bulk of the hydrophilic inorganic salts will separate into first aqueous solution 116 and according to some embodiments, be removed from the system at 146 as described in detail hereinabove.

The hydrophobic solutes (organic acids) are selectively and efficiently extracted into the first organic phase 118 in the first contacting 110. The hydrophobic solutes remain practically fully in the extractant during the second contacting, i.e. in the second organic phase 128. In the depicted exemplary embodiment of FIG. 1,2 or 3 a fraction of the hydrophobic solutes arrive at evaporation 150 and is at least partially removed from the system at 152. Separated water (depicted as permeate 136) becomes feed process water to the industrial process and can be used as part of input water for a subsequent round of production of synthetic crude oil.

### Exemplary Use Scenario III: Cooling Water

In Israel water-cooled condensers are estimated to consume some 130 million M³ of water each year and discharge 35 million M³ of brines each year. The brines contain about 5.6 tons of chlorides/M³ and about tons of 2.6 tons of sodium/M³.

Since water-cooled condensers are widely used in large public institutions throughout the country, it is estimated that about 50 million M³ of water are consumed each year for air conditioning alone.

Even larger amounts of cooling water are used in an industrial context. As an example, a single refinery can require about 350 M³/hour of cooling water. Of this amount, about 60 to 80% is lost to evaporation in cooling towers and the remaining 20 to 40% is recovered as cooled water which is, at least theoretically, available for recycling. Because minerals do not evaporate, salts are concentrated in the cooling tower by a factor of about 2.5 to 5.

This means that recycling of cooled water without treatment to remove dissolved minerals will cause an increase in the mineral concentration in water circulating in the cooling system over time.

Referring again to FIGS. 1,2,3 and 4: in some exemplary embodiments of the invention, cooling in a cooling tower serves as industrial process and the cooled water serves as wastewater stream 106.

During water recovery process 100, the bulk of the hydrophilic inorganic salts will separate into first aqueous solution 116 and according to some embodiments, be removed from the system at 146 as described in detail hereinabove. Separated water 136 becomes feed process water and can be used as part of input water for a subsequent round of cooling.

Water recovery processes 100, 200 and 300 are suitable to treat wastewater stream 106 from the oil industry (e.g. refineries) and cooling towers from various industries. In some cases, an oil refinery includes one or more cooling towers so that there are multiple sources of wastewater. According to various exemplary embodiments of the invention these multiple sources of wastewater are treated according to method 100 either separately or in combination with one another.

Exemplary Use Scenario IV: Effluents from Petroleum Industry Processing

In a petroleum refinery, processing includes various treatments (e.g. cracking, which is the process in which heavy hydrocarbons are broken down to lighter hydrocarbons). These processing treatments produce wastewater streams including hydrophilic solutes. These hydrophilic solutes can include, but are not limited to cyanide salts, thiocyanate salts, salts of ammonia and sulfides (e.g. H₂S). In addition the waste can include hydrophobic solutes such as oils and/or phenols. The phenols can include the monohydrics (having one hydroxyl group) such as phenol; o-, m-, and p-cresols, the various xylenols, and the various ethylphenols. The phenols may also include polyhydrics (having two or more hydroxyl groups) such as catechol and resorcinol which are C₆H₄(OH)₂ isomers. Alternatively or additionally, the phenols may include thiophenols such as benzenethiol (or phenyl mercaptan) which is C₆H₅SH and toluenethiols (or tolyl mercaptans) which are CH₃C₆H₄SH isomers.

For example, petroleum industry processing wastewater stream can include ≦50 mg cyanides or thiocyanates and/or ≧500 mg/L ammonia or ammonium salts and/or ≧500 mg/L sulfides as hydrophilic solutes. The same stream may also include 50 to 500 mg/L of phenols and/or 50 to 500 mg/L of oils as hydrophobic solutes.

Referring again to FIGS. 1,2,3 and 4: in some exemplary embodiments of the invention, petroleum industry processing serves as industrial process and wastewater produced during the processing serves as wastewater stream 106.

During water recovery processes 100, 200 and 300 the bulk of the hydrophilic inorganic salts will separate into first aqueous solution 116 and according to some embodiments, be removed from the system at 146 as described in detail hereinabove.

The hydrophobic solutes (phenols and/or oils) are selectively and efficiently extracted into the first organic phase 118 in the first contacting 110. The hydrophobic solutes remain practically fully in the extractant during the second contacting, i.e. in the second organic phase 128. In the depicted exemplary embodiment of FIG. 1, a fraction of the hydrophobic solutes arrive at evaporation 150 and is at least partially removed from the system at 152. Separated water 136 becomes feed process water and can be used as part of input water for a subsequent round of any of the processing treatments.

### Exemplary Use Scenario V: Enhanced Oil Recovery (EOR)

The EOR process is similar production of oil from oil sand (scenario II above) in that it involves pumping water down into a well. In EOR liquid water penetrates oil in the bottom of the well and accumulates underneath the oil. As the water accumulates it raises the oil until the oil reaches a level at which it can be pumped from the well. The oil pumped from the well using EOR contains about 20 to 30% water carrying a high concentration of salts which can contain metals and/or radioisotopes. In order to re-use this water it must be separated from the oil and the salt concentration must be reduced.

Referring again to FIGS. 1,2,3 and 4: in some exemplary embodiments of the invention, EOR serves as industrial process and water separated from recovered crude oil serves as wastewater stream 106.

During water recovery processes 100, 200 and 300, the bulk of the hydrophilic inorganic salts, metals and radioisotopes will separate into first aqueous solution 116 and according to some embodiments, be removed from the system at 146 as described in detail hereinabove.

The hydrophobic solutes (suspended oil droplets) are selectively and efficiently extracted into the first organic phase 118 in the first contacting 110. The hydrophobic solutes remain practically fully in the extractant during the second contacting, i.e. in the second organic phase 128. In the depicted exemplary embodiment of FIGS. 1, 2 and 3, a fraction of the hydrophobic solutes arrive at evaporation 150 and is at least partially removed from the system at 152. Separated water 136 becomes feed process water and can be used as part of input water for a subsequent round of EOR.

### EXAMPLES

### Example 1

### Water Extraction from a Waste Stream Using Recycled n-Butanol Extractant

A flowback waste stream was contacted (extracted) with recycled n-butanol (the bidirectional solvent). The waste stream (Aqueous Feed to extraction) contained 3% total dissolved solutes (TDS), mainly salts (hydrophilic solutes), and about 200 ppm oil-related organic matter (crude-oil-associated hydrophobic solutes). The recycled (regenerated) n-butanol (Extractant) contained initially about 11.5% water. The bench scale extraction was conducted at 35° C. and simulated counter-currently extraction of 8 stages. Water transferred from the waste stream to the Extractant. The Extractant to Aqueous Feed (O/A) weight/weight ratio was 11. The formed organic phases and aqueous phases were analyzed to determine the time when their composition has reached a steady state. The steady state organic phase (Extract) and the steady state aqueous phase (Raffinate) were analyzed.

The TDS of the Raffinate was 12%. Its n-butanol concentration was 2.7% and the concentration of oil-related organic matter was less than 20 ppm. The water content if the Extract was 17. These analyses indicate that about 75% of the water and essentially all the oil-related organic matter initially present in the waste stream got extracted into the n-butanol. The formed Raffinate is the water-depleted first aqueous solution and the formed extract is the water-enriched first organic phase.

### Examples 2-6

### Water Extraction from Various Waste Stream Using Recycled n-Butanol Extractants

Additional waste stream of varying compositions were extracted with recycled n-butanol (Extractants) of varying initial water content. The procedure was similar to that in Example 1 and the results are summarized in Table 1.

TABLE 1

| | | Extract- | | | | |
|---|---|---|---|---|---|---|
| | Waste | ant | | | Extract | Water |
| | stream | water | O/A | | water | extraction |
| | TDS | content | (weight/ | Raffinate | content | yield |
| | (%) | (%) | weight) | TDS (%) | (%) | (%) [1] |
| Example 2 | 1 | 8.2 | 7 | 20 | 18.5 | 95 |
| Example 3 | 1 | 11.4 | 11 | 12 | 18.5 | 90 |
| Example 4 | 3 | 12.2 | 12 | 10 | 17 | 70 |
| Example 5 | 3 | 7 | 7 | 23.5 | 17 | 85 |
| Example 6 | 10 | 7 | 9 | 23.5 | 12 | 55 |

[1] Calculated as the fraction of water in the waste stream that got extracted into the Extract.

### Examples 7-11

### Water Extraction from a Waste Stream Using Various Recycled Extractants

Waste stream of various initial TDS were extracted with various recycled Extractants. The procedure was similar to that in Example 1 and the results are summarized in Table 2.

TABLE 2

| | | waste | Extractant | | | Extract | |
|---|---|---|---|---|---|---|---|
| | | stream | water | O/A | raffinate | water | Water |
| | | TDS | content | (weight/ | TDS | content | extraction |
| | extractant | (%) | (%) | weight) | (%) | (%) | yield [1] |
| Example 7 | Sec-BuOH | 3 | 11 | 5 | 12 | 22.5 | 75 |
| Example 8 | Tert-butyl | 8.5 | 10.2 | 2 | 23 | 31 | 68 |
| | alcohol | | | | | | |
| Example 9 | Tert-amyl | 5 | 9.8 | 9 | 20 | 17.3 | 75 |
| | alcohol | | | | | | |
| Example 10 | Phenol | 5 | 17 | 7 | 20 | 25 | 75 |
| Example 11 | Methyl- | 1 | 6.6 | 16 | 11 | 11.4 | 90 |
| | ethyl | | | | | | |
| | ketone | | | | | | |

[1] Calculated as the fraction of water in the waste stream that got extracted into the Extract.

### Example 12

### Back-Extraction of Extract Formed in Example 1 by Means of MgCl2 Solution

The Extract formed in Experiment 1 was contacted (back-extracted) with recycled (regenerated) aqueous 11% MgCl2 solution. The bench scale back-extraction was conducted at 35° C. and simulated counter-currently extraction of 8 stages. The Extract to Aqueous MgCl2 solution (O/A) weight/weight ratio was 5. Water transferred from the Extract to the MgCl2 solution. The formed organic phases and aqueous phases were analyzed to determine the time when their composition has reached a steady state. The steady state organic phase (regenerated Extractant) and the steady state aqueous phase (diluted MgCl2 solution) were analyzed.

MgCl2 concentration in the diluted MgCl2 solution was 8. The water content of the regenerated Extract was 11.5%. The water extracted from the waste stream into the extract according to Example 1, transferred from the extract to the recycled MgCl2 solution in this back-extraction, regenerating the extractant of Example 1.

### Examples 13-17

### Back-Extraction of the Extracts Formed in Examples 7-11 by Means of MgCl2 Solution

The extracts formed in Examples 7-11 were back-extracted with MgCl2 solution. The procedure was similar to that in Example 12. The results are summarized in Table 3. Back-extraction has transferred into the MgCl2 solutions the water that got extracted in Exp. 7-11, respectively, and has regenerated the respective extractants.

TABLE 3

| | | | | MgCl2 | |
|---|---|---|---|---|---|
| | | | | concentration | Water |
| | | | | in the | concentration |
| | Extract | | Extract | recycled | in the |
| | formed | | water | MgCl2 | regenerated |
| | in Exp. | | content | solution | Extractant |
| | # | Extractant | (%) | (%) | (%) |
| Example | 7 | Sec-BuOH | 22.5 | 11 | 11 |
| 13 | | | | | |
| Example | 8 | Tert-butyl | 31 | 21 | 10.2 |
| 14 | | alcohol | | | |
| Example | 9 | Tert-amyl | 17.3 | 18 | 9.8 |
| 15 | | alcohol | | | |
| Example | 10 | Phenol | 25 | 18 | 17 |
| 16 | | | | | |
| Example | 11 | Methyl-ethyl | 11.4 | 10 | 6.6 |
| 17 | | ketone | | | |

### Examples 18

### Water Removal from the Diluted MgCl2 Solution of Example 12 by Means of Evaporation

100 g of the diluted MgCl2 solution formed in Exp. 12 was heated under vacuum and the formed vapors was condensed into a liquid and collected. The collected liquid contained water and n-butanol. Heating was stopped when the amount of condensed water was 27 g. After cooling, the MgCl2 solution was analyzed. The MgCl2 concentration there was 11%, which regenerated the recycled MgCl2 solution. Water extracted from the waste stream into the extract in Example 1 and back-extracted into the MgCl2 solution in Example 12 was recovered from the diluted MgCl2 by evaporation from that diluted MgCl2 solution.

### Examples 19

### Water Removal from the Diluted MgCl2 Solution of Example 12 by Means of Reverse Osmosis

Diluted MgCl2 solution Formed in Exp. 12 was Concentrated in a Reverse Osmosis Cell to reach a concentration of 11%. Water transferred through the membrane, while MgCl2 was rejected. The concentration of MgCl2 was Increased to Regenerate the Recycled MgCl2 solution of Exp. 12. A small organic phase separated from the concentrated MgCl2 solution.

### Example 20

### Back-Extraction of Extract Formed in Example 1 by Means of Ammonium Carbonate Solution

A ammonia and CO2 were bubbled through a recycled, dilute aqueous solution of ammonium carbonate to form a concentrated solution of about 20%.

The Extract formed in Experiment 1 was contacted (back-extracted) with the concentrated solution. The bench scale back-extraction was conducted at 15° C. and simulated counter-currently extraction of 8 stages. The Extract to Aqueous (NH4)2CO3 solution (O/A) weight/weight ratio was 5. Water transferred from the Extract to the (NH4)2CO3 solution. The formed organic phases and aqueous phases were analyzed to determine the time when their composition has reached a steady state. The steady state organic phase (regenerated Extractant) and the steady state aqueous phase (diluted (NH4)2CO3 solution) were analyzed.

The water content of the regenerated Extract was 11.5%. The water extracted from the waste stream into the extract according to Example 1, transferred from the extract to the recycled (NH4)2CO3 solution in this back-extraction, regenerating the extractant of Example 1.

It is expected that during the life of this patent many additional industrial processes and/or desalination techniques will be developed and the scope of the invention is intended to include all such new technologies a priori.

As used herein the term “about” refers to ±10%.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Specifically, a variety of numerical indicators have been utilized. It should be understood that these numerical indicators could vary even further based upon a variety of engineering principles, materials, intended use and designs incorporated into the various embodiments of the invention. Additionally, components and/or actions ascribed to exemplary embodiments of the invention and depicted as a single unit may be divided into subunits. Conversely, components and/or actions ascribed to exemplary embodiments of the invention and depicted as sub-units/individual actions may be combined into a single unit/action with the described/depicted function.

Alternatively, or additionally, features used to describe a method can be used to characterize an apparatus and features used to describe an apparatus can be used to characterize a method.

It should be further understood that the individual features described hereinabove can be combined in all possible combinations and sub-combinations to produce additional embodiments of the invention. The examples given above are exemplary in nature and are not intended to limit the scope of the invention which is defined solely by the following claims.

Each recitation of an embodiment of the invention that includes a specific feature, part, component, module or process is an explicit statement that additional embodiments not including the recited feature, part, component, module or process exist.

Specifically, the invention has been described in the context of industrial processes and desalination but might also be used to reduce levels of radioisotopes in water.

All publications, references, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “include”, and “have” and their conjugates as used herein mean “including but not necessarily limited to”.

1-42. (canceled)

43. A method comprising:
(a) first contacting at least a portion of a wastewater stream comprising one or more hydrophilic solutes with an extractant comprising a bi-directional solvent to form a water-depleted first aqueous solution and a water-enriched first organic phase;
(b) second contacting said first organic phase with a concentrated aqueous solution, to form a second organic phase and a second aqueous solution;
(c) separating water from said second aqueous solution to form a concentrated aqueous solution and separated water;
(d) recycling said concentrated aqueous solution to said second contacting; and
(e) recycling bi-directional solvent from said second organic phase to said first contacting;
wherein water partial vapor pressure at 50° C. of said wastewater stream, said water-depleted first aqueous solution, said concentrated aqueous solution and said second aqueous solution are P1, P2, P3 and P4, respectively; and wherein said bi-directional solvent is selected so that P1>P2; P1>P3 and P4>P3.

44. A method according to claim 43, wherein said wastewater stream comprises one or more crude-oil-associated hydrophobic solutes; comprising separating at least a portion of said one or more crude-oil-associated hydrophobic solutes from at least a portion of said second organic phase.

45. A method according to claim 43, wherein said separating water comprises heating said second aqueous solution and said heating separates a gaseous or solid compound, comprising contacting said separated gaseous or solid compound with a third aqueous solution to form said concentrated aqueous solution.

46. A method according to claim 45, wherein said gaseous or solid compound includes at least one member of the group consisting of NH₃, CO, CO₂, CaCl₂, Ca(NO₂)₃, KBr, KCl, KHCO₃, K₂SO₄, MgCl₂, MgSO₄, NaCl, NaHCO₃, Na₂SO₄, NH₄Cl, (NH₄)₂CO₃, (NH₄)HCO₃, H₂NCOONH₄ and (NH₄)₂SO₄.

47. A method according to claim 43, wherein said separating water comprises contacting said second aqueous solution with a reverse osmosis membrane to form separated water and a retentate.

48. A method according to claim 47, wherein said second aqueous solution comprises at least a portion of said bi-directional solvent and said retentate comprises a fourth organic phase.

49. A method according to claim 43, wherein said separated water comprises at least 60% of the water in at least a portion of said wastewater stream.

50. A method according to claim 43, wherein P2>P3, wherein P1>P4 or both.

51. A method according to claim 43, wherein said bi-directional solvent has a greater affinity to monovalent ions compared to divalent ions; wherein said wastewater stream comprises at least one multivalent ion and at least one monovalent ion at a multivalent to monovalent ion ratio R1, wherein said first aqueous solution comprises at least one multivalent ion and at least one monovalent ion at a multivalent to monovalent ion ratio R2, and wherein R2 is similar to R1.

52. A method according to claim 43, comprising contacting at least a fraction of at least one of said first organic phase and said second organic phase with a hydrophobic solvent having a C:O ratio at least 2 times greater than the C:O ratio in said bi-directional solvent.

53. A method according to claim 44, wherein said one or more crude-oil-associated hydrophobic solutes comprise at least one member of the group consisting of naphthenic acid, other organic acids comprising at least 5 carbon atoms, 1,4-dioxane, acetone, bromoform, dibenzo(a,h)anthracene, pyridine, phenols and oil.

54. A method according to claim 44, wherein said second organic phase comprises at least 85% of said one or more crude-oil-associated hydrophobic solutes in said wastewater stream.

55. A method according to claim 43, wherein said water-depleted first aqueous solution comprises at least 80% of said one or more hydrophilic solutes in said wastewater stream.

56. A method according to claim 43, comprising recycling at least 50% of water from said wastewater stream to an industrial process producing said wastewater stream.

57. A method according to claim 43, wherein said wastewater stream is produced by an industrial process selected from the group consisting of induced hydraulic fracturing (fracking), crude oil production from oil sand, steam-assisted gravity drainage (SAGD), petroleum industry processing, enhanced oil recovery (EOR), vegetable oil production, recovering crude oil and processing crude oil.

58. A method according to claim 43, comprising contacting crude oil with said separated water to produce said wastewater stream.

59. A method according to claim 43, wherein said bi-directional solvent comprises one or more members of the group consisting of alcohols, ketones, esters, phenols and organic acids with 3 to 6 carbon atoms.

60. A method according to claim 44, wherein the bidirectional solvent is selected so that the ratio of said one or more hydrophilic solutes to said one or more crude-oil-associated hydrophobic solutes is at least ten times higher in said water-depleted first aqueous solution than in said wastewater stream.

61. A method according to claim 44, wherein the concentration of at least one of said one or more crude-oil-associated hydrophobic solutes in said extractant is at least three times higher than the concentration of said at least one of said one or more crude-oil-associated hydrophobic solutes in said wastewater stream just prior to said first contacting.

62. A system comprising:
(a) a wastewater source producing a wastewater stream comprising one or more hydrophilic solutes;
(b) an extractant source comprising an extractant including a bi-directional solvent;
(c) a first extraction module in fluid communication with said extractant source and adapted to contact said extractant with at least a portion of said wastewater stream to form a water-depleted first aqueous solution and a water-enriched first organic phase;
(d) a second extraction module adapted to receive said first organic phase and contact said first organic phase with a concentrated aqueous solution, to produce a second organic phase and a second aqueous solution;
(e) a separation module adapted to separate water and a solute from said second aqueous solution;
(f) a pump adapted to route at least a portion of said solute to said second water extraction module as recycled aqueous solution; and
(g) a solvent pump directing at least a portion of said second organic phase to said first water extraction module.
